(19) United States
(12) Patent Application Publication
(10) Pub. No.: US 2009/0140500 A1
(43) Pub. Date: Jun. 4, 2009

(54) Tool-Holding Chuck for Equipping a Rotating Machine

(75) Inventor: Yves Marie Marcel Cachod, Levier (FR)

Correspondence Address: OLIFF & BERRIDGE, PLC, P.O. BOX 320850, ALEXANDRIA, VA, 22320-4850, US

(73) Assignee: ETABLISSEMENTS AMYOT S.A., PONTARLIER (FR)

(21) Appl. No.: 11/885,502

(22) PCT Filed: Mar. 16, 2006
(86) PCT No.: PCT/FR2006/000589

§ 371 Date: Nov. 8, 2007

(30) Foreign Application Priority Data
Mar. 16, 2005 (FR) 0502588

(51) Int. Cl. B23B 31/12

(52) U.S. Cl. 279/62

(57) ABSTRACT

The invention concerns a mandrel comprising a body (2) wherein are mounted, guided in translation, several jaws (7) which converge forward to clamp a tool. Each jaw (7) has a rectangular cross-section, and is guided in a groove with complementary profile provided in the body, the orientation of each jaw (7) is such that its side (10) facing inside is located in a plane substantially tangent to a circle (12) centered on the axis of the mandrel, and each jaw (7) is positioned in the body such that the longitudinal median plane (P) of its side (10) facing inside is offset relative to the contact line on a circle (12) centered on the axis of the mandrel and representing the shank of a tool, so as to provide a contact with said circle an edge (13), called active edge, delimiting said inner side (10), and located in front or tangent in the clamping direction.

The subject of the present invention is a tool-holding chuck for equipping a rotating machine.

### BACKGROUND OF THE INVENTION

A chuck grips a tool by means of jaws, usually three jaws set out at angles of 120° from each other. The jaws converge toward the front of the tool and it is possible to move them toward each other to grip a tool, or to draw them back so that they open out and release the tool. This axial movement of the jaws, accompanied by a radial movement, also allows the opening between the jaws to be adapted to the diameter of the tool which it is wished to clamp.

### DESCRIPTION OF THE PRIOR ART

In the prior art, the body of the chuck includes cavities of generally cylindrical shape by which jaws of complementary shape are guided. This requires complex machining operations, both to make the jaw guide cavities and to make the jaws themselves, because the jaws, which are roughly cylindrical in their guidance region inside the chuck, have ends which are differently shaped, typically tapering ends and with an edge on the inside, so that the tool is clamped by three edges belonging to the three jaws.

Although the methods used in the prior art are satisfactory from a technical point of view, they are very expensive to implement, particularly because of the number of machining operations required.

### SUMMARY OF THE INVENTION

It is therefore an object of the invention to provide a chuck whose jaws are produced in a simple and inexpensive manner.

To this end, the chuck to which it relates, which is of the type comprising a body in which are mounted, with guidance for translational movement, a number of jaws that converge in the forward direction to clamp a tool, each jaw comprising a toothed section facing outward or inward to engage with a drive member situated on the outside or on the inside, is characterized in that:
each jaw is of rectangular section and is guided in a mating groove formed in the body,
the orientation of each jaw is such that its inward-turned face is situated in a plane essentially tangent to a circle concentric with the chuck axis, and
each jaw is positioned in the body in such a way that the longitudinal mid-plane of its inward-turned face is offset from the line of contact on a circle concentric with the chuck axis, this circle representing the shank of a tool, in such a way as to contact this circle along an edge termed the axial edge which delimits this inward-turned face and is situated forward of or tangent to it in the clamping direction.

Since the cross section of each jaw is rectangular, it can be produced by simple means, such as by cutting a metal plate of suitable thickness equal to the thickness of the jaws. This type of jaw can also be produced by simple operations such as forging operations.

It should be observed that the rectangular shape of the jaws nonetheless allows clamping by edges, since the offset positions of the jaws, as stated earlier, allow contact with the tool shank along an edge termed the active edge delimiting the inward face of each jaw. It may be pointed out that if the shank of the tool to be clamped is hexagonal, the three planar inward faces will bear on three of six faces of the tool and ensure that it clamps rigidly.

The inward-turned face of each jaw advantageously forms an angle of a few degrees on the outward side, with the tangent to a circle concentric with the chuck axis, passing through the point of contact between the active edge and this circle. This feature will clamp a circular tool shank along three edges corresponding to the active edges of the innermost face of each of the three jaws.

In another advantageous feature of the invention, the toothed section of each jaw is defined by notches having walls perpendicular to the longitudinal plane of the jaw.

This feature is advantageous because the toothed sections are produced by a simple process, by simple cutting, but can still mesh with a thread because of the offset positions of the jaws with respect to a position in which the longitudinal plane of each jaw would pass through the chuck axis.

To retain each jaw inside a rectangular cavity in the body, each jaw has, in at least one of its lateral faces, at least one longitudinal groove for engagement with at least one stud projecting from the adjacent face of the wall of the groove in which the jaw is engaged and guided.

In one possible arrangement, the toothed section of each jaw is formed in the inward-turned face of the jaw and engages with a threaded central head with a left-hand pitch to move the jaws in either direction depending on the direction in which the body and head are rotated.

In another possible arrangement, the toothed section of each jaw is formed on the outward-turned face of the jaw and engages with an external nut driven by a sleeve which pivots on the body.

However, the invention will be understood clearly from a perusal of the following description, with reference to the appended schematic drawing showing, by way of non-restricted example, an embodiment of this chuck.

### DESCRIPTION OF THE DRAWINGS

FIG. 1 is a perspective view showing the chuck clamping a tool whose shank is of hexagonal section;

FIG. 2 is a front view of the chuck seen in FIG. 1;

FIG. 3 is a perspective view of two jaws of this chuck, clamped on the same tool, the outside of the chuck having been removed;

FIG. 4 is a front view of this chuck clamped on a cylindrical drill bit; and

FIG. 5 is a longitudinal sectional view on V-V as marked in FIG. 4.

The chuck shown in FIGS. 1-5 comprises a body 2 in which is fitted a central head 3 for its attachment to the spindle of a rotating machine, this central head 3 being externally threaded 4 at its forward end. The chuck is equipped with a holding ring 5 connected to the central head, and, at its forward end, with a clamping ring 6. The body 2 has three rectangular-sectioned longitudinal recesses, each holding and guiding a jaw 7. As in the prior art, the cavities formed in the body 2 converge toward the front so that the jaws 7 come together when moved axially forward. It should be observed that each jaw is rectangular in cross section and can therefore be produced in a simple manner by, for example, cutting it out of a plate of given thickness.

On the inward-turned face of each jaw is a toothed section 8 in the form of a series of notches having walls perpendicular to the longitudinal plane of the jaws. As shown in FIG. 3, in one of the lateral faces of each jaw is a longitudinal groove 9 for engagement with at least one stud projecting from the adjacent face of the wall of the groove in which the jaw in question is engaged and guided.

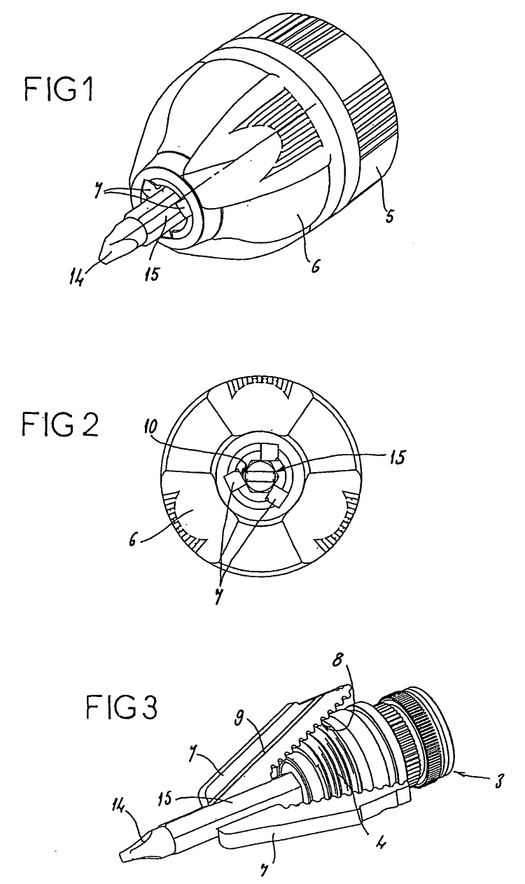

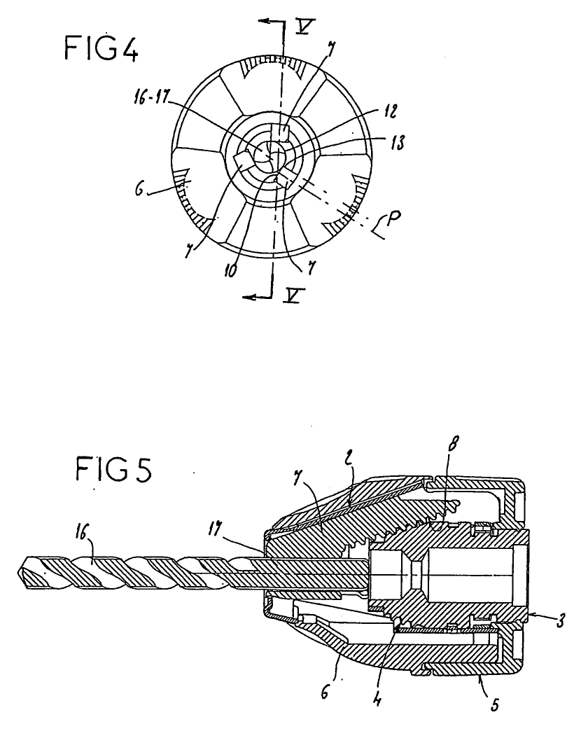

As shown in FIGS. 2 and 4, the inner face 10 of each jaw is situated in a plane approximately tangent to a circle 12 concentric with the chuck axis.

Each jaw is also positioned in the body in such a way that the longitudinal mid-plane P of its face 10 is offset from its line of contact on a circle concentric with the chuck axis, this circle representing the shank of the tool. In this way the contact with the circle takes place along an edge 13 termed the active edge, which is situated forward of or tangent to it in the tool clamping direction. If the tool 14 has a hexagonal-sectioned shank 15, as shown in FIGS. 1 and 2, clamping will take place by the three inner faces 10 of the jaws bearing on three faces of the tool shank 15.

If the tool is a drill bit 16 whose shank 17 is cylindrical, as shown in FIGS. 4 and 5, the shank 17 is clamped along three active edges 13 of the three jaws.

It will be seen from the above that the invention is a great improvement on the existing technique by providing a chuck of simple structure, in that its jaws may be made by very simple, cheap mechanical or forging operations.

The invention is not of course limited to the one embodiment of a chuck comprising a central head threaded with a left-hand pitch: on the contrary, it encompasses all variants thereof. To take one example, the toothed section of each jaw could be formed on the outward-turned face of the jaw and engage with an external nut driven by a sleeve pivoting on the body, without thereby departing from the scope of the invention.

1. A tool-holding chuck for equipping a rotating machine, of the type comprising a body in which are mounted, with guidance for translational movement, a number of jaws that converge in the forward direction to clamp a tool, each jaw comprising a toothed section facing outward or inward to engage with a drive member situated on the outside or on the inside, in which chuck:
each jaw is of rectangular section and is guided in a mating groove formed in the body,
the orientation of each jaw is such that its inward-turned face is situated in a plane essentially tangent to a circle concentric with the chuck axis, and
each jaw is positioned in the body in such a way that the longitudinal mid-plane of its inward-turned face is offset from the line of contact on a circle concentric with the chuck axis, this circle representing the shank of a tool, in such a way as to contact this circle along an edge termed the axial edge which delimits this inward-turned face and is situated forward of or tangent to it in the clamping direction.

2. The chuck as claimed in claim 1, wherein the inward-turned face of each jaw forms an angle of a few degrees on the outward side, with the tangent to a circle concentric with the chuck axis, passing through the point of contact between the active edge and this circle.

3. The chuck as claimed in claim 1, wherein the toothed section of each jaw is defined by notches having walls perpendicular to the longitudinal plane of the jaw.

4. The chuck as claimed in claim 1, wherein each jaw has, in at least one of its lateral faces, at least one longitudinal groove for engagement with at least one stud projecting from the adjacent face of the wall of the groove in which the jaw is engaged and guided.

5. The chuck as claimed in claim 1, wherein the toothed section of each jaw is formed in the inward-turned face of the jaw and engages with a threaded central head with a left-hand pitch to move the jaws in either direction depending on the direction in which the body and head are rotated.

6. The chuck as claimed in claim 1, wherein the toothed section of each jaw is formed on the outward-turned face of the jaw and engages with an external nut driven by a sleeve which pivots on the body.
